(19) United States
(12) Patent Application Publication
(10) Pub. No.: US 2006/0278771 A1
(43) Pub. Date: Dec. 14, 2006

(54) Load carrying apparatus with security detection system

(75) Inventors: Pin-Hsin Ho, Taichung (TW); Yu-Mei Chen, Dali City (TW)

Correspondence Address: CHARLES E. BAXLEY, ESQ., 90 JOHN STREET, THIRD FLOOR, NEW YORK, NY, 10038, US

(73) Assignee: Charder Electronic Co., Ltd.

(21) Appl. No.: 11/151,048

(22) Filed: Jun. 13, 2005

(51) Int. Cl. B60J 7/08; F16M 11/00

(52) U.S. Cl. 248/122.1; 296/107.01; 248/125.8; 248/129

(57) ABSTRACT

A load carrying apparatus with security detection system provided in accordance with the present invention comprises: a base includes a vertical connecting rod and a plurality of cantilevers welded at peripheral surface of the connecting rod, the respective cantilevers are provided with a hook; a security detection system includes a plurality of strain meters being secured to the respective cantilevers of the base and located close to the connecting rod. When a load is hanging from the cantilevers, the cantilevers will be deformed, and the security detection system will detect a deformation of the detection system and output data.

### BACKGROUND OF THE INVENTION

1. Field of the Invention

The present invention relates to a medical load carrying apparatus, and more particularly to a medical load carrying apparatus equipped with security detection system that is capable of preventing the load carrying apparatus from being overloaded.

2. Description of the Prior Arts

In hospital, serious injuries who are unable to walk on their own need to be lifted by the nurse, from bed into wheelchair, or from wheelchair into bed, when they are going to have a medical examination or to go to toilet. When there are enough nurses, they can carry the patient directly by using the bed sheet.

However, the fact is, in today's medical system, a nurse always needs to take care of more than ten patients at the same time, therefore, the workload of a nurse is very heavy. Furthermore, lifting patient by hands, in the long term, is likely to cause great hurts to the nurse's backbone.

Carrying the patient with bed sheet is also not so ideal, not all the nurses can firmly grip the bet sheet when carrying the patient, since the nurses are different from each other in height and arm length, four corners of the bed sheet are not hold in the same level, this will consequently lead to a slide of the patient towards the lowest corner of the bed sheet, and the patient will feel uncomfortable. And because the patient's load is focused on the lowest portion of the bed sheet, the nurse who grips the lower corner will feel hard to firmly hold the bed sheet, presenting a risk of slippage of the bed sheet from the nurse's hand, thus causing damage to the patient.

The present invention has arisen to mitigate and/or obviate the afore-described disadvantages.

### SUMMARY OF THE INVENTION

The primary objective of the present invention is to provide a medical load carrying apparatus with security detection system that is capable of checking that if the weight loaded on the load carrying apparatus exceeds a default value, thus preventing the load carrying apparatus from being overloaded.

A load carrying apparatus with security detection system provided in accordance with the present invention comprises:

a base includes a vertical connecting rod and a plurality of cantilevers welded at peripheral surface of the connecting rod, the respective cantilevers are provided with a hook;

a security detection system includes a plurality of strain meters being secured to the respective cantilevers of the base and located close to the connecting rod; and

when a load is hanging from the cantilevers, the cantilevers will be deformed, and the security detection system will detect a deformation of the detection system and output data.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a load carrying apparatus with security detection system in accordance with the present invention;

FIG. 2 is an assembly view of a load carrying apparatus with security detection system in accordance with the present invention;

FIG. 3 is an enlarged view of a part of the load carrying apparatus with security detection system in accordance with the present invention;

FIG. 4 is an operational view of the load carrying apparatus with security detection system in accordance with the present invention;

FIG. 5 shows a load carrying apparatus with a hanging security detection system in accordance with the present invention;

FIG. 6 shows a load carrying apparatus with security detection system in accordance with the present invention, a display and a buzzer;

FIG. 7 is another operational view of the load carrying apparatus with security detection system in accordance with the present invention.

### DETAILED DESCRIPTION OF THE PREFERRED EMBODIMENTS

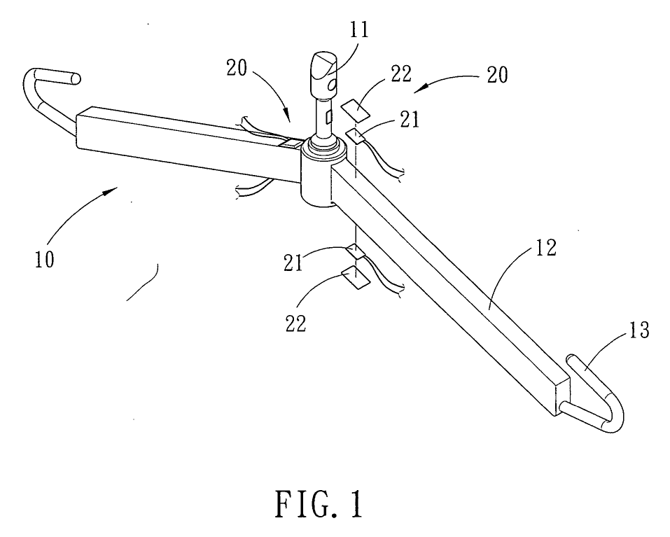

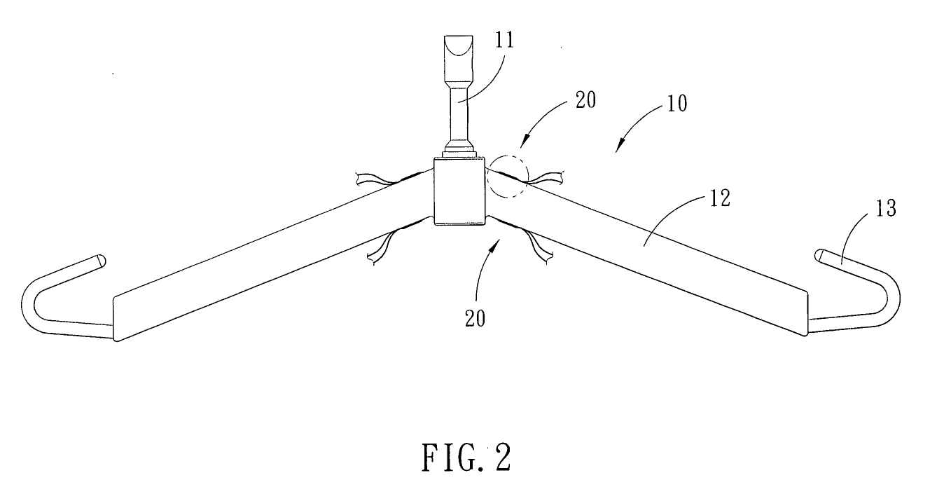

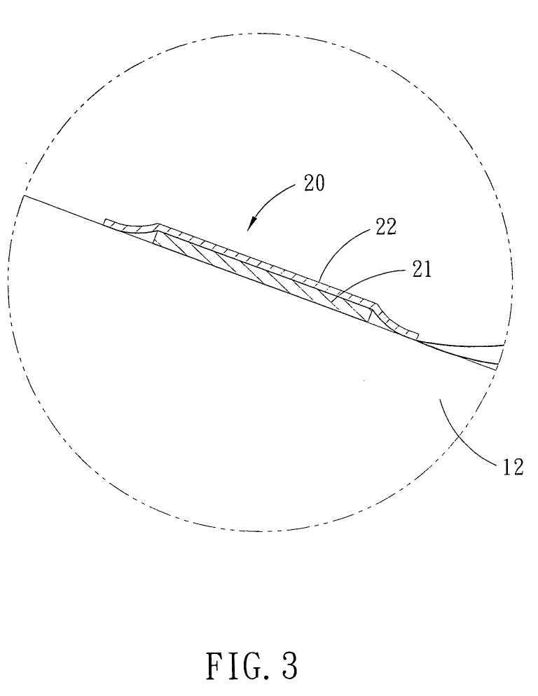

Referring to FIGS. 1-3, a load carrying apparatus with security detection system in accordance with the present invention comprises a base 10 and a security detection system 20.

The base 10 comprises a vertical connecting rod 11 and two cantilevers 12 oppositely welded at either side of the connecting rod 11. The cantilevers 12 extend outward and downward from the connecting rod 11, and at an end of the respective cantilevers 12 is defined a hook 13 with a tip end facing toward the connecting rod 11.

The detection system 20 comprises a plurality of strain meters 21 and silicon gel plates 22. The strain meters 21 are attached to the upper and lower surface of the respective cantilevers 12, by the silicon gel plates 22 and located close to the connecting rod 11.

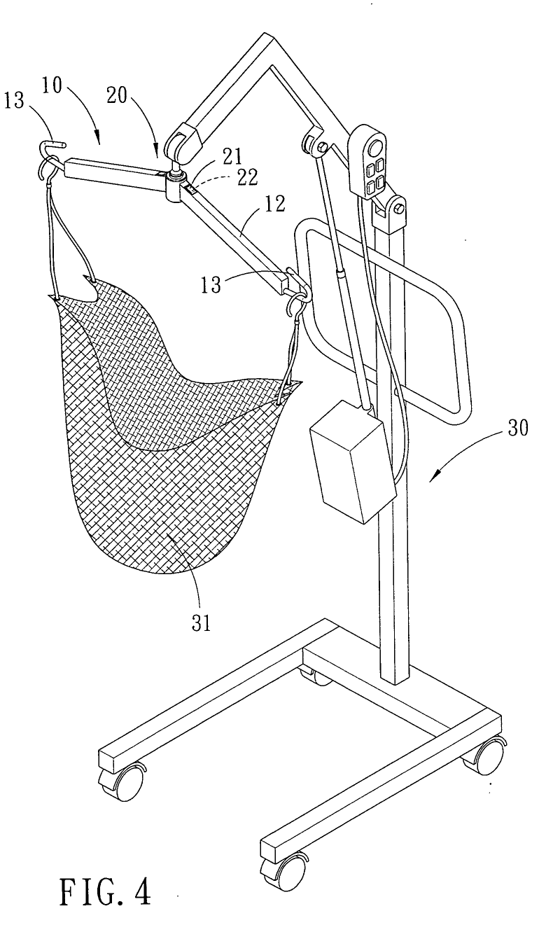

For a better understanding of the present invention, and its operation and function, reference should be made to FIG. 4, the load carrying apparatus with security detection system in accordance with the present invention is used on a patient carrying device 30. A hanging cradle 31 is suspended to the hooks 13 of the base 10 of the load carrying apparatus, when a patient is carried in the hanging cradle 31, the patient's weight will cause deformation of the cantilevers 12 of the base 10. At this moment, the strain meters 21 of the security detection system 20 detects the deformation of the cantilevers 12 and outputs the detected data to the patient carrying device 30, and then alarm signals, like light or acoustic signal, will be generated to indicate the status of the loading carrying device. Therefore, the patient carrying device 30 can be prevented from being overloaded, ensuring the patient to be safely carried. Or, the data can be transmitted to and processed by a computer, so as to figure out the weight of the patient.

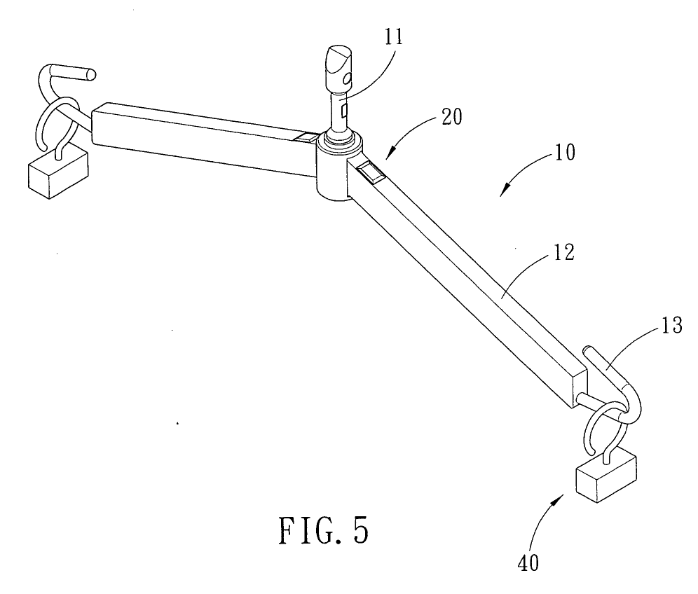

Referring to FIG. 5, besides the security detection system 20 on the cantilevers 12, the base 10 also can be provided with hanging security detecting system 40 that is secured to the hooks 13 of the base 10 of the load carrying apparatus, thus improving the precision and reliability of the load carrying apparatus.

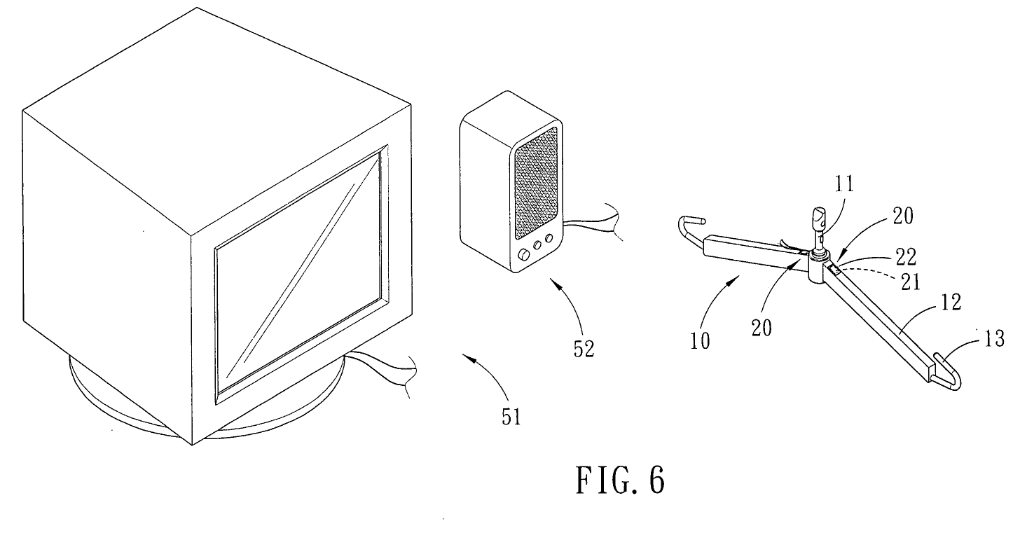

Referring to FIG. 6, the strain meters 21 of the security detection system 20 are electrically connected to a display 51 and a buzzer 52, so that, when the deformation of the cantilevers 12 exceeds the default value, the strain meters 21 will send the detected data to the display 51 and the buzzer 52, the buzzer 52 will alarm to remind the nurse that the carried load is greater than the load capacity of the load carrying apparatus, and the detail weight value of the patient will be displayed on the display 52.

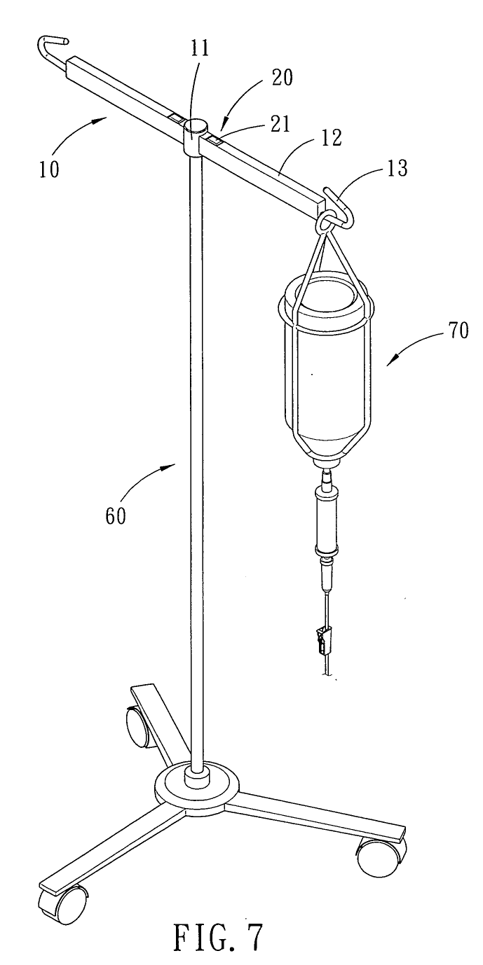

Referring to FIG. 7, the load carrying apparatus with security detection system in accordance with the present invention is used on an intravenous drip, wherein the connecting rod 11 of the base 10 of the load carrying apparatus is provided at its bottom thereof with a supporting frame 60 that stands firmly on the ground. Furthermore, the two cantilevers 12 welded at both sides of the connecting rod 11 are arranged in a horizontal plane. The hooks 13 of the load carrying apparatus are provided for hanging the drip bottle 70. When the cantilevers 12 are deformed after being loaded with the drip bottle 70, the strain meters 21 will detect the deformation value and output it to an alarm system of a nursing station, so that the intravenous drip is kept closely under the control of the nursing station.

While we have shown and described various embodiments in accordance with the present invention, it should be clear to those skilled in the art that further embodiments may be made without departing from the scope of the present invention.

What is claimed is:

1. A load carrying apparatus with security detection system comprising:
a base including a vertical connecting rod and a plurality of cantilevers welded at peripheral surface of the connecting rod, the respective cantilevers provided with a hook;
a security detection system including a plurality of strain meters being secured to the respective cantilevers of the base and located close to the connecting rod; and
when a load is hanging from the cantilevers, the cantilevers will be deformed, and the security detection system will detect a deformation of the detection system and output data.

2. The load carrying apparatus with security detection system as claimed in claim 1, wherein the strain meters of the security detection system is electrically connected to a display, so that the data outputted from the stain meters will be displayed on the display.

3. The load carrying apparatus with security detection system as claimed in claim 1, wherein the strain meters of the security detection system is electrically connected to a buzzer, and the data outputted from the stain meters will be transmitted to the buzzer.

4. The load carrying apparatus with security detection system as claimed in claim 1, wherein the cantilevers of the base of the load carrying apparatus extend outward and downward from the connecting rod.

5. The load carrying apparatus with security detection system as claimed in claim 1, wherein the cantilevers of the base of the load carrying apparatus are arrange in a horizontal plane.

6. The load carrying apparatus with security detection system as claimed in claim 1, wherein a tip end of the respective hooks of the base of the load carrying apparatus faces toward the connecting rod.

7. The load carrying apparatus with security detection system as claimed in claim 1, wherein the stain meters of the security detecting system are attached to the cantilevers and fixed by silicon gel plates.

8. The load carrying apparatus with security detection system as claimed in claim 1, wherein a hanging security detection system is secured to the hooks of the base of the load carrying apparatus.

9. The load carrying apparatus with security detection system as claimed in claim 1, wherein the connecting rod of the base of the load carrying apparatus is provided at its bottom thereof with a supporting frame that stands firmly on the ground, and the hooks of the load carrying apparatus are provided for hanging drip bottle.
